(19) United States
(12) Patent Application Publication
(10) Pub. No.: US 2026/0155066 A1
(43) Pub. Date: Jun. 4, 2026

(54) Snap Fit Shelf Talker

(71) Applicant: Dana Industries Inc., Etobicoke (CA)

(72) Inventors: John Ricci, Kleinburg (CA); Frank Borges, Toronto (CA); Sonia Anesetti, Etobicoke (CA)

(21) Appl. No.: 19/403,824

(22) Filed: Nov. 29, 2025

Related U.S. Application Data
(60) Provisional application No. 63/726,578, filed on Dec. 1, 2024.

(51) Int. Cl. G09F 3/20

(52) U.S. Cl. CPC G09F 3/204

(57) ABSTRACT

A shelf talker includes a first, shelf engaging portion having a top edge and a bottom edge, and a crease there-between. The shelf talker further includes a second sign portion extending from the first portion.

### CROSS REFERENCE TO RELATED APPLICATIONS

The present application claims priority to U.S. Application No. 63/726,578, filed Dec. 1, 2024, the contents of which are incorporated herein by reference.

### FIELD OF THE DESCRIPTION

The present disclosure relates to shelf talker with an improved means for attaching to shelves.

### BACKGROUND

Signage commonly referred to as “shelf talkers” are known to be used by vendors to display information, pricing, advertisement, or other such details in relation to products. This type of signage comprises a mounting or anchor portion, for fastening to a shelf, and a sign portion wherein the information being conveyed to the customer is displayed. In some cases, the sign portion depends upwardly or downwardly so as to allow customers to read the information when standing in front of the product. In other cases, the sign portion may protrude away from the shelf, sometimes orthogonal thereto, thereby serving to attract an approaching customer before the customer reaches the location of the product. As will be understood, the latter type of “shelf talkers” may be used to draw the attention of customers to a specific product or products. Examples of shelf talkers are described in U.S. Pat. No. 9,153,148, U.S. D694,828, U.S. D921,760, and U.S. D960,240.

Shelf talkers are commonly attached to shelving using an adhesive or a specific attachment means or mechanism. In the latter instance the shelf talkers may be designed with a clip to be secured to an attachment means provided on the shelf. While effective, such attachment method involves additional material costs and installation time.

Digital shelf labels are also well-known in the art. Such labels comprise a generally flat cartridge that is attached to the front edge of a shelf. Typically, the shelf would be provided with an edge rail and the digital label is adapted to be attached thereto. Such digital labels are illustrated, for example, in U.S. D909,478. This reference also illustrates shelf talkers that are specifically designed for attachment to or with a digital label. In this way, the digital label may display the price of a product and the shelf talker may display other information, such an advertisement etc. relating to the product.

There exists a need for a shelf talker with a simplified attachment means, particularly for use with digital labels or the like.

### SUMMARY OF THE DESCRIPTION

In one embodiment, there is provided a shelf talker having a reversibly deformable shelf attachment portion that is able to be temporarily deformed for insertion into a channel provided on the edge a shelf and that returns to its normal shape wherein it is retained in the channel.

Thus, in one embodiment, a shelf talker comprises:
a first, shelf engaging portion having a longitudinal axis, a top edge and a bottom edge extending in parallel with the longitudinal axis, and a bendable crease between the top edge and bottom edge and extending in parallel with the longitudinal axis; and
a second sign portion extending from the first portion.

### BRIEF DESCRIPTION OF THE FIGURES

The features of certain embodiments will become more apparent in the following detailed description in which reference is made to the appended figures wherein:

FIG. 1 is a front elevational view of a blank used for forming a shelf talker according to an embodiment of the present disclosure.

FIGS. 2 to 5 illustrate the steps for installing the shelf talker of FIG. 1 on to a shelf.

FIG. 6 is a front view of the shelf talker of FIG. 1 once attached to a shelf.

### DETAILED DESCRIPTION

The terms “comprise”, “comprises”, “comprised” or “comprising” may be used in the present description. As used herein (including the specification and/or the claims), and unless stated otherwise, these terms are to be interpreted as open-ended terms and as specifying the presence of the stated features, integers, steps or components, but not as precluding the presence of one or more other feature, integer, step, component or a group thereof as would be apparent to persons having ordinary skill in the relevant art. Thus, the term “comprising” as used in this specification means “consisting at least in part of”. When interpreting statements in this specification that include that term, the features, prefaced by that term in each statement, all need to be present but other features can also be present. Related terms such as “comprise” and “comprised” are to be interpreted in the same manner.

Unless stated otherwise herein, the articles “a” and “the”, when used to identify an element, are not intended to constitute a limitation of just one and will, instead, be understood to mean “at least one” or “one or more”.

In the following description, it is to be understood that the terms “top, “bottom”, “left”, “right” and the like, will be used. These terms are meant to describe the orientation of the components of the present disclosure when the shelf talker is positioned upright and are not intended to limit the scope of the subject matter in any way. As such, these terms will be understood to mean relative orientations and positional relationships and are not intended to mean orientations and positional relationships with respect to an external reference point.

The term “embodiment” is used herein to describe one or more examples of representations or implementations of one or more features, elements, structures, or characteristics etc. (collectively “features”) of the present description. It will be understood that the features of a given embodiment of the description are not necessarily limited to such embodiment. In other words, any of the features described herein with respect to one embodiment may be used with, incorporated into, or combined with any of the described embodiments as would be understood by persons skilled in the art.

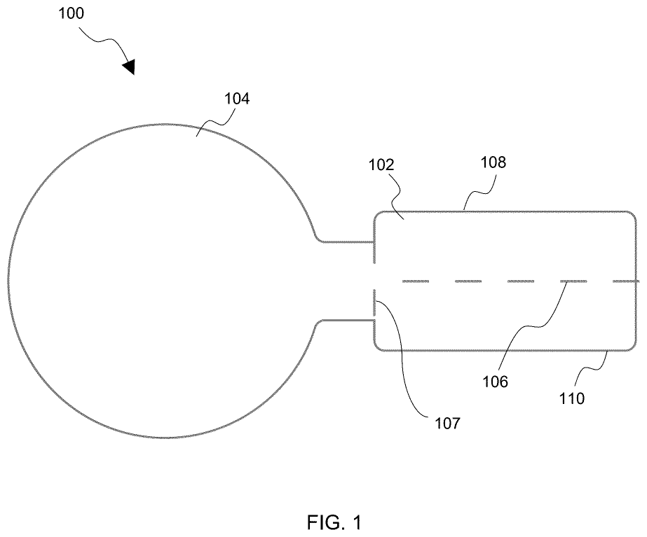

FIG. 1 illustrates a shelf talker 100 in accordance with an embodiment of the present disclosure. The shelf talker 100 comprises a first, shelf attachment portion 102 and a second, sign portion 104. As will be further discussed, the first portion 102 is particularly suitable for being secured to a front edge of a shelf, and in particular, to an edge rail of a shelf as known in the art. Such edge rails comprise a channel having top and bottom tracks for securing a signage article, such as a digital label. It will be understood that the edge rails may be formed as part of the shelf or may be a separate component that is attached to the shelf.

As shown, the first portion 102 includes a top edge 108 and bottom edge 110. The first portion 102 is also provided with a crease 106 extending in parallel with the top edge 108 and bottom edge 110. In a preferred embodiment, the crease 106 extends along a longitudinal centerline of the first portion 102. The crease 106 results in a weakened portion of the first portion 102, whereby, upon squeezing or pressing the top edge 108 and bottom edge 110 together causes the first portion 102 to bend along the crease 106. For this purpose, and as noted above, the shelf talker 100, and in particular the first portion 102, is ideally formed of a resilient or flexible thermoplastic material. Accordingly, once the force squeezing the top edge 108 and bottom edge 110 together is released, such edges are forced apart and the first portion 102 generally returns to a flat form, as shown in FIG. 1.

In one embodiment, the second portion 104 is preferably provided at an angle to the first portion. In a preferred embodiment, the second portion 104 extends generally orthogonal to the first portion 102. Such arrangement is known in the art and as described above, serves to attract the attention of customers. To achieve the angular arrangement between the first and second portions, 102 and 104, the shelf talker is bent at a bend line 107, which delineates the first portion 102 from the second portion 104. In one embodiment, the shelf talker 100 is formed of a plastic material, in particular a thermoplastic or similar material that is capable of being heat formed. In such case, the bend line 107 may be formed by applying heat and forming the bend thereafter. After cooling, the bend will be retained thus giving the shelf talker 100 a desired shape.

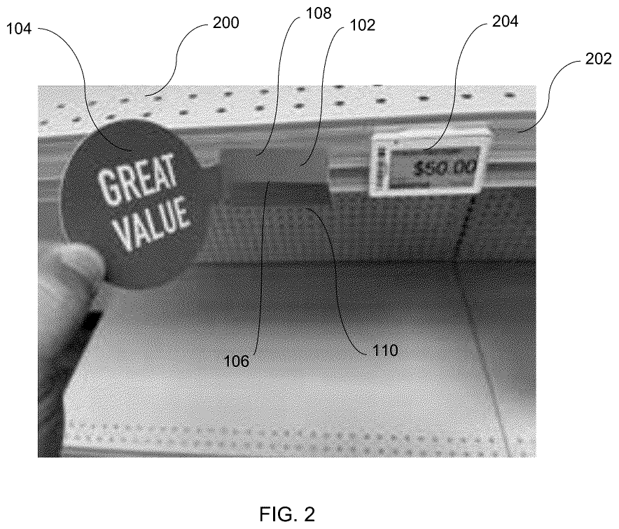

FIGS. 2 to 5 illustrate the installation of the subject shelf talker to a shelf. As discussed above, and as known to persons skilled in the art, shelving 200 used in commercial applications, such as grocery stores and the like, is usually provided with an edge rail or strip 202 having a generally “C” shaped channel with upper and lower tracks and a body there-between. The convex part of the body is attached to the edge of the shelf and the concave part of the body is oriented away from the edge of the shelf. The concave portion is adapted to receive devices, such as digital labels as mentioned above and an example of which is shown at 204. It will be understood that the edge rail may comprise a separate article that is attached to an edge of a shelf, as shown in the accompanying drawings. However, it will also be appreciated that a shelf may be formed with an integral edge rail, such as with the upper and lower tracks formed therein. The present description is not limited to any particular edge rail.

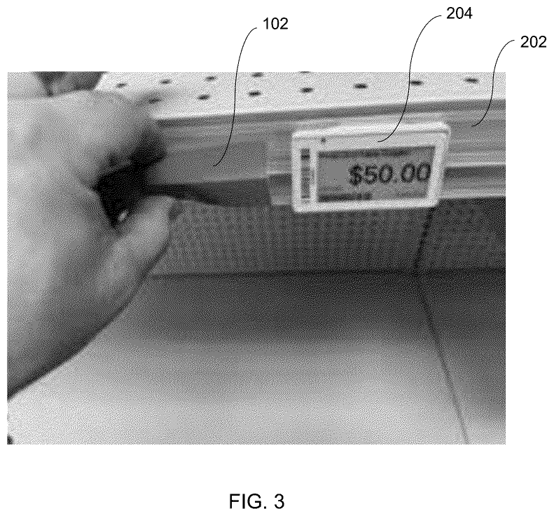

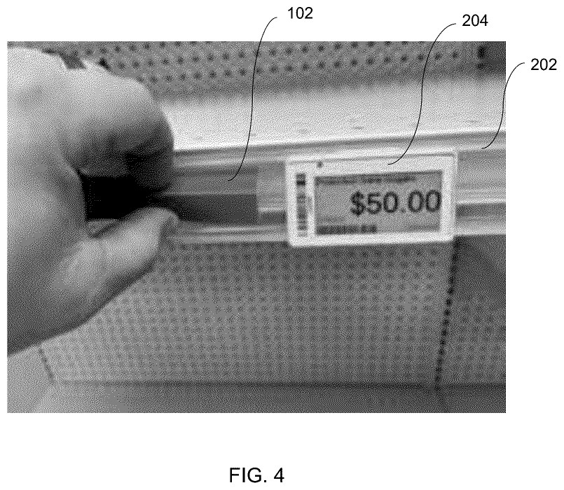

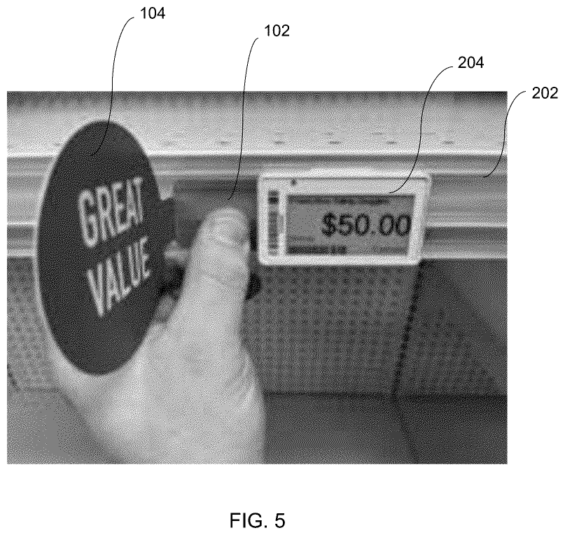

During installation of the present shelf talker 100, and as shown in FIG. 2, a user aligns the first portion 102 of the shelf talker 100 with a label, for example, a digital label, which is previously attached to the shelf. To attach the shelf talker, a user pinches the top edge 108 and the bottom edge 110 of the first portion 102 towards each other to cause a temporary bend along the crease 106, as shown in FIG. 3. The user then inserts the first portion 102 into the concave portion of the edge strip 202, as shown in FIG. 4. Once inserted in this manner, the force squeezing the top edge 108 and bottom edge 110 is released whereupon the first portion 102 assumes its original, generally flattened shape and, in doing so, the top edge 108 and bottom edge 110 of the first portion 102 are expanded within the concave portion of the edge strip 202 and are thereby engaged within the upper and lower tracks of the edge rail. This is illustrated in FIG. 5. It will be understood, that in one embodiment, the first portion 102 may be urged into its original shape or into engagement within the edge rail by pressing on the crease 106.

To further ensure that the shelf talker 100 is retained in place, the first portion 102 may preferably be slid along the channel of the edge strip 202 and positioned behind the shelf label 204, as shown in FIG. 5.

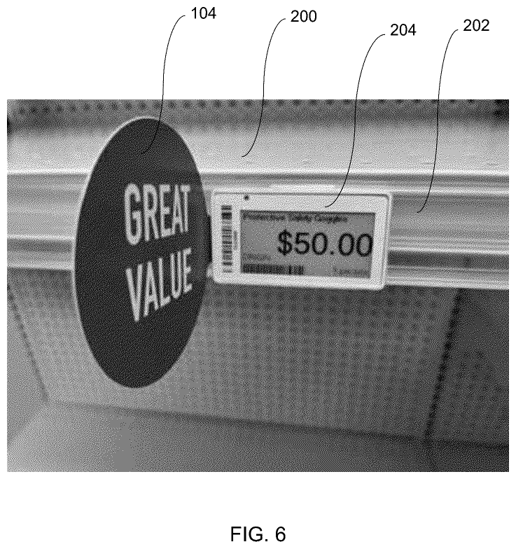

FIG. 6 illustrates the shelf talker fully secured within the concave portion of the edge strip 202 and positioned behind the shelf label 204. As shown, once in this position, the first portion 102 is generally hidden behind the digital label 204, whereas the second portion 104 of the shelf talker 100 is then positioned for viewing.

It will be understood that the shelf talker 100 may be removed by performing the above steps in reverse order.

As will be understood, the sign portion 104 is provided to attract the attention of customers. For this reason, the sign portion 104 is designed to extend away from the first portion 102 and, therefore, the shelf, once the shelf talker 100 is installed. The sign portion 104 can be of any shape or design and is not limited to the form illustrated in the figures. Moreover, although having the sign portion 104 extend away from the shelf may be preferred, this is not mandatory. The sign portion 104 may, for example, be provided in parallel with the first, shelf attachment portion 102 and may include other visual features for serving the purpose of attracting customer attention.

Although the above description includes reference to certain specific embodiments, various modifications thereof will be apparent to those skilled in the art. Any examples provided herein are included solely for the purpose of illustration and are not intended to be limiting in any way. Any drawings provided herein are solely for the purpose of illustrating various aspects of the description and are not intended to be drawn to scale or to be limiting in any way. The scope of the claims appended hereto should not be limited by the preferred embodiments set forth in the above description but should be given the broadest interpretation consistent with the present specification as a whole. The disclosures of all references in the present description herein are incorporated herein by reference in their entirety.

We claim:

1. A shelf talker comprising:
a first, shelf engaging portion having a longitudinal axis, a top edge and a bottom edge extending in parallel with the longitudinal axis, and a bendable crease between the top edge and bottom edge and extending in parallel with the longitudinal axis; and
a second sign portion extending from the first portion.

2. The shelf talker of claim 1, wherein the second portion extends at an angle to a plane of the first portion.

3. The shelf talker of claim 1, wherein the first portion comprises a resilient material whereby, when in use, the first portion is bent along the crease upon application of a force urging the top edge and bottom edge together and is unbent upon release of the force.

4. The shelf talker of claim 1, wherein the first portion is adapted to engage an edge rail of a shelf.
